(19) United States
(12) Patent Application Publication
(10) Pub. No.: US 2026/0045545 A1
(43) Pub. Date: Feb. 12, 2026

(54) SECONDARY BATTERY

(71) Applicant: MURATA MANUFACTURING CO., LTD., Kyoto (JP)

(72) Inventors: Kikou YAMAGUCHI, Kyoto (JP); Yasuyuki MASUDA, Kyoto (JP)

(21) Appl. No.: 19/285,787

(22) Filed: Jul. 30, 2025

(30) Foreign Application Priority Data
Aug. 7, 2024 (JP) 2024-131231

(51) Int. Cl. H01M 10/0565; H01M 10/0525

(52) U.S. Cl. CPC H01M 10/0565; H01M 10/0525; H01M 2300/0034; H01M 2300/0037

(57) ABSTRACT

A secondary battery is provided and includes a positive electrode, a negative electrode, and an electrolytic solution. The electrolytic solution contains at least one of first compounds represented by Formula (1), Formula (2), or Formula (3):

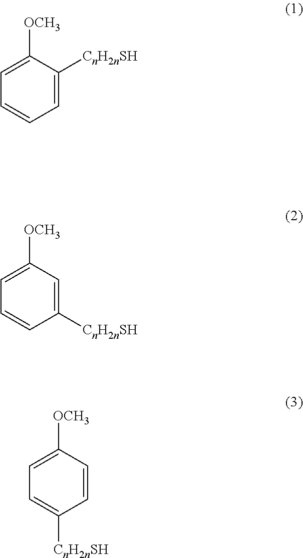

wherein n is an integer of 0 or more and 5 or less.

### CROSS REFERENCE TO RELATED APPLICATIONS

The present application claims priority to Japanese Patent Application No. 2024-131231, filed on Aug. 7, 2024, the entire contents of which are incorporated herein by reference.

### BACKGROUND

The present technology relates to a secondary battery.

A secondary battery using an electrolytic solution containing anisole is disclosed in Moon, J., Kim, D. O., Bekaert, L. et al. Non-fluorinated non-solvating cosolvent enabling superior performance of lithium metal negative electrode battery. Nature Communications 13, 4538 (2022).

However, in the secondary battery described in Moon, J., Kim, D. O., Bekaert, L. et al. Non-fluorinated non-solvating cosolvent enabling superior performance of lithium metal negative electrode battery. Nature Communications 13, 4538 (2022), there is a possibility that the charge-discharge characteristics are deteriorated due to coordination of anisole to lithium ions.

### SUMMARY

The present technology relates to a secondary battery.

The present disclosure, in an embodiment, relates to providing a secondary battery having improved charge-discharge characteristics.

A secondary battery according to an aspect of the present disclosure includes a positive electrode, a negative electrode, and an electrolytic solution, and the electrolytic solution contains at least one of first compounds represented by Formula (1), Formula (2), or Formula (3).

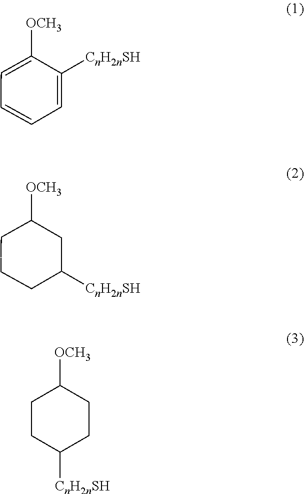

Here, n is an integer of 0 or more and 5 or less.

According to the present disclosure, a secondary battery having improved charge-discharge characteristics can be provided according to an embodiment.

### BRIEF DESCRIPTION OF THE FIGURES

FIG. 1 is a perspective view illustrating a configuration of a secondary battery according to an embodiment; and

FIG. 2 is an enlarged sectional view illustrating a configuration of the battery element illustrated in FIG. 1.

### DETAILED DESCRIPTION

The present technology will be described in further detail including with reference to the drawings according to an embodiment. Note that the present disclosure is not limited thereto.

A secondary battery according to the present embodiment will be described. The secondary battery according to the present embodiment is a secondary battery that can obtain a battery capacity by utilizing occlusion and release of an electrode reactant and includes a positive electrode, a negative electrode, and an electrolytic solution.

The kind of the electrode reactant is not particularly limited, and is specifically a light metal such as an alkali metal or an alkaline earth metal. Specific examples of the alkali metal include lithium, sodium, and potassium. Specific examples of the alkaline earth metal include beryllium, magnesium, and calcium.

In the following description, a case where the electrode reactant is lithium will be described as an example. A secondary battery capable of obtaining a battery capacity by utilizing occlusion and release of lithium is, for example, a lithium ion secondary battery. In the lithium ion secondary battery, lithium is occluded and released in an ionic state.

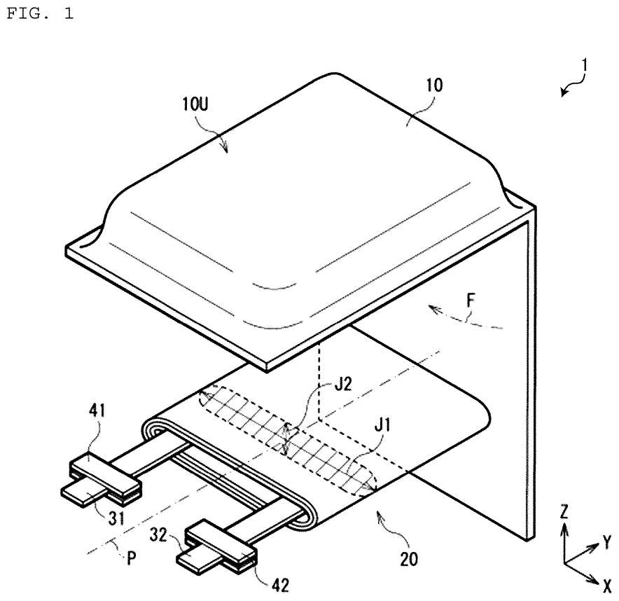

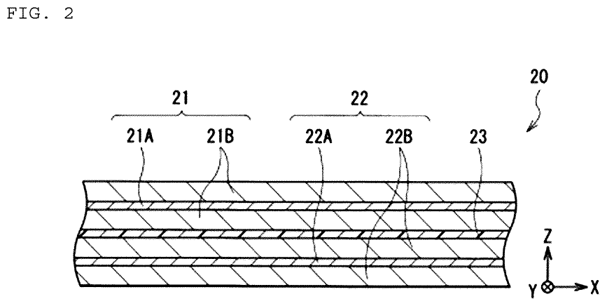

FIG. 1 is a perspective view illustrating a configuration of a secondary battery according to an embodiment. FIG. 2 is an enlarged sectional view illustrating a configuration of the battery element illustrated in FIG. 1. FIG. 1 illustrates a state in which the exterior film 10 and the battery element 20 are separated from each other, and a section of the battery element 20 is indicated by a broken line. FIG. 2 illustrates a section of only a part of the battery element 20.

As illustrated in FIGS. 1 and 2, the secondary battery 1 includes an exterior film 10, a battery element 20, a positive electrode lead 31, a negative electrode lead 32, and sealing films 41 and 42.

As described above, the secondary battery 1 according to FIG. 1 uses the exterior film 10 as an exterior member for housing the battery element 20. Thus, the secondary battery 1 illustrated in FIG. 1 is a so-called laminate film type secondary battery.

As illustrated in FIG. 1, the exterior film 10 is an exterior member having flexibility or bendability, and has a bag-shaped structure in which the battery element 20 is sealed in a housed state. With such a configuration, the exterior film 10 houses a positive electrode 21, a negative electrode 22, a separator 23, and an electrolytic solution (not shown in the drawing) which will be described later.

In the example of FIG. 1, the exterior film 10 is a single film-shaped member, and is folded in the folding direction F. The exterior film 10 is provided with a recess 10U for housing of the battery element 20. The recess 10U is a so-called deep drawn portion.

Specifically, the exterior film 10 is a three-layer laminate film in which a fusion layer, a metal layer, and a surface protective layer are laminated in this order from the inside. In a state where the exterior film 10 is folded, outer peripheries of the fusion layer portions facing each other are fused to each other. The fusion layer contains a polymer compound such as polypropylene. The metal layer contains a metal material such as aluminum. The surface protective layer contains a polymer compound such as nylon. The configuration (number of layers) of the exterior film 10 is not particularly limited, and may be one layer, two layers, or four or more layers.

The battery element 20 is housed in a space of the recess 100 of the exterior film 10. The battery element 20 is a so-called power generating element. As illustrated in FIGS. 1 and 2, the battery element 20 includes a positive electrode 21, a negative electrode 22, a separator 23, and an electrolytic solution (not shown).

In the example of FIG. 1, the battery element 20 is a so-called wound electrode body. Thus, the positive electrode 21 and the negative electrode 22 are wound around the winding axis P while facing each other with the separator 23 interposed therebetween. In the following description, a direction along the winding axis P may be referred to as a Y direction, a longer direction of the battery element 20 in a direction perpendicular to the winding axis P may be referred to as an X direction, and a shorter direction of the battery element 20 in a direction perpendicular to the winding axis P may be referred to as a Z direction.

In the example of FIG. 1, the battery element 20 has a flat three-dimensional shape. That is, the shape of the section (section along the XZ plane) of the battery element 20 intersecting the winding axis P of the battery element 20 is a flat shape defined by the major axis J1 and the minor axis J2. The major axis J1 is an imaginary axis extending in the X-axis direction, and has a length larger than the length of the minor axis J2. The minor axis J2 is an imaginary axis extending in the Z-axis direction, and has a length smaller than the length of the major axis J1. As a result, the sectional shape of the battery element 20 is a flat substantially elliptical shape. The three-dimensional shape of the battery element 20 is an example, and is not limited to the above.

As illustrated in FIG. 2, the positive electrode 21 includes a positive electrode current collector 21A and a positive electrode active material layer 21B. However, the positive electrode current collector 21A may be omitted.

The positive electrode current collector 21A has a pair of surfaces on which the positive electrode active material layer 21B is provided. The positive electrode current collector 21A contains a conductive material such as a metal material, for example, aluminum.

The positive electrode active material layer 21B contains at least one or more kinds of positive electrode active materials that occlude and release lithium. However, the positive electrode active material layer 21B may further contain one or more other materials such as a positive electrode binder and a positive electrode conductive agent. The method for forming the positive electrode active material layer 21B is not particularly limited, and is specifically a coating method or the like.

In the example of FIG. 2, the positive electrode active material layer 21B is provided on both surfaces of the positive electrode current collector 21A. However, the positive electrode active material layer 21B may be provided only on one surface of the positive electrode current collector 21A on the side where the positive electrode 21 faces the negative electrode 22.

The kind of the positive electrode active material is not particularly limited, and is specifically a lithium-containing compound or the like. The lithium-containing compound is a compound containing lithium and one or more transition metal elements as the constituent elements. The lithium-containing compound may further contain one or more other elements as the constituent element. The kind of the other element is not particularly limited as long as it is an element other than lithium or a transition metal element, and is specifically an element belonging to Groups 2 to 15 in the long form of the periodic table. The kind of the lithium-containing compound is not particularly limited, and specifically, an oxide, a phosphoric acid compound, a silicic acid compound, a boric acid compound, and the like may be used.

Examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Examples of the phosphate compound include LiFePO₄, LiMnPO₄, LiFe_{0.5}Mn_{0.5}PO₄, and LiFe_{0.3}Mn_{0.7}PO₄.

The positive electrode binder contains at least one or more kinds of materials such as synthetic rubber and a polymer compound. Specific examples of the synthetic rubber include styrene-butadiene rubber, fluorine rubber, and ethylene propylene diene. Specific examples of the polymer compound include polyvinylidene fluoride, polyimide, and carboxymethyl cellulose.

The positive electrode conductive agent contains at least one or more kinds of conductive materials such as a carbon material, a metal material, and a conductive polymer compound, and specific examples of the carbon material include graphite, carbon black, acetylene black, and Ketjen black.

As illustrated in FIG. 2, the negative electrode 22 includes a negative electrode current collector 22A and a negative electrode active material layer 22B. However, the negative electrode current collector 22A may be omitted.

The negative electrode current collector 22A has a pair of surfaces on which the negative electrode active material layer 22B is provided. The negative electrode current collector 22A contains a conductive material such as a metal material, for example, copper.

The negative electrode active material layer 22B contains at least one or more kinds of negative electrode active materials that occlude and release lithium. However, the negative electrode active material layer 22B may further contain at least one or more kinds of other materials such as a negative electrode binder and a negative electrode conductive agent. The method for forming the negative electrode active material layer 22B is not particularly limited, and specifically, is at least one or more kinds of a coating method, a gas phase method, a liquid phase method, a thermal spraying method, a firing method (sintering method), or the like.

In the example of FIG. 2, the negative electrode active material layer 22B is provided on both surfaces of the negative electrode current collector 22A. However, the negative electrode active material layer 22B may be provided only on one surface of the negative electrode current collector 22A on the side where the negative electrode 22 faces the positive electrode 21.

The kind of the negative electrode active material is not particularly limited, and is specifically a carbon material, a metal-based material, or the like. With this, a high energy density can be obtained. Specific examples of the carbon material include graphitizable carbon, non-graphitizable carbon, and graphite. The graphite may be one or both of natural graphite and artificial graphite. The metal-based material is a general term for materials containing at least one or more kinds of metal or metalloid elements capable of forming an alloy with lithium as the constituent element, and specific examples of the metal elements and the metalloid elements include silicon and tin. The metal-based material may be a simple substance, an alloy, or a compound. The metal-based material may be a mixture of two or more kinds of materials, or may be a material containing two or more kinds of phases. The simple substance may contain any suitable amount of impurities. Specific examples of the metal-based material include TiSi₂ and SiOₓ (0<x≤2).

As the negative electrode binder, the same material as the above-described positive electrode binder may be used. As the negative electrode conductive agent, the same material as the above-described positive electrode conductive agent may be used.

As illustrated in FIG. 2, the separator 23 is an insulating porous membrane interposed between the positive electrode 21 and the negative electrode 22. The separator 23 allows lithium in an ionic state to pass therethrough while preventing short circuit resulting from contact of the positive electrode 21 and the negative electrode 22. The separator 23 contains at least one or more kinds of insulating polymer compounds. Specific examples of the insulating polymer compound include polyethylene.

Each of the positive electrode 21, the negative electrode 22, and the separator 23 is impregnated with the electrolytic solution. The electrolytic solution will be described in detail later.

As illustrated in FIGS. 1 and 2, the positive electrode lead 31 is a positive electrode wiring connected to the positive electrode current collector 21A of the positive electrode 21, and is extended to the outside of the exterior film 10. The positive electrode lead 31 contains at least one or more kinds of conductive materials such as metal materials, and specific examples of the conductive material include aluminum. The shape of the positive electrode lead 31 is not particularly limited, and is, for example, a thin plate shape, a mesh shape, or the like.

As illustrated in FIGS. 1 and 2, the negative electrode lead 32 is a negative electrode wiring connected to the negative electrode current collector 22A of the negative electrode 22, and is extended to the outside of the exterior film 10. The negative electrode lead 32 contains at least one or more kinds of conductive materials such as metal materials. Specific examples of the conductive material include copper. The shape of the negative electrode lead 32 is not particularly limited, and is, for example, a thin plate shape, a mesh shape, or the like.

As illustrated in FIG. 1, the sealing film 41 is inserted between the exterior film 10 and the positive electrode lead 31. As illustrated in FIG. 1, the sealing film 42 is inserted between the exterior film 10 and the negative electrode lead 32. However, one or both of the sealing films 41 and 42 may be omitted.

The sealing film 41 is a sealing member that prevents entry of outside air and the like into the exterior film 10. The sealing film 41 contains a polymer compound such as a polyolefin having a close contact property to the positive electrode lead 31. Specific examples of the polymer compound include polypropylene.

The sealing film 42 is a sealing member that prevents entry of outside air and the like into the exterior film 10. The sealing film 42 contains a polymer compound such as a polyolefin having a close contact property to the negative electrode lead 32. Specific examples of the polymer compound include polypropylene.

Hereinafter, the electrolytic solution according to the present embodiment will be described in detail.

The electrolytic solution contains a solvent and an electrolyte salt.

The solvent contains at least one of first compounds represented by Formula (1), Formula (2), or Formula (3). The number of carbon atoms represented by n in Formula (1), Formula (2), and Formula (3) is 0 or more and 5 or less. That is, the first compound is a compound in which one of the hydrogens bonded to the benzene ring of anisole is replaced with a thiol group (—SH) or an alkylthiol group (—CₙH₂ₙSH, wherein n is an integer of 1 or more and 5 or less). This allows for an increase of the boiling point of the electrolytic solution to reduce the volatility and flammability of the electrolytic solution, thereby improving safety. In addition, the first compound is less likely to be solvated with an alkali metal ion such as a lithium ion. Thus, it is possible to suppress a decrease in the concentration of unsolvated alkali metal ions in the electrolytic solution. As a result, since the decomposition of the anion of the electrolytic solution on the negative electrode surface is promoted by the presence of alkali metal ions, a coating film derived from the anion of the electrolytic solution, such as Solid Electrolyte Interphase (SEI) is favorably formed on the negative electrode 22, and thus the charge-discharge characteristics can be improved.

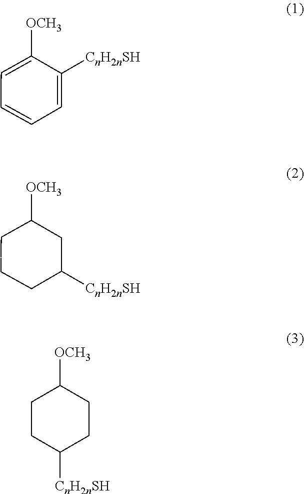

Here, the alkylthiol group in Formula (1), Formula (2), and Formula (3) refers to a functional group in which one hydrogen of an alkyl group (—CₙH₂ₙ₊₁, wherein n is an integer of 1 or more and 5 or less) is replaced with a thiol group (—SH). Specific examples of the alkyl group are a methyl group, an ethyl group, a propyl group, a butyl group, and a pentyl group. The alkyl group may be linear or branched. Thus, for example, the butyl group may be an n-butyl group, a sec-butyl group, an isobutyl group, or a tert-butyl group.

The number of carbon atoms represented by n in Formula (1), Formula (2), and Formula (3) is more preferably 0 or 1. That is, the solvent preferably contains, as the first compound(s), at least one of compounds in which one of the hydrogens bonded to the benzene ring of anisole is replaced with a thiol group (—SH) or a methylthiol group (—CH₂SH). This makes it possible to improve the solubility of the solute in the first compound(s) and the compatibility with a solvent such as the second compound(s).

Specific examples of the first compound include compounds represented by Formulae (4) to (6).

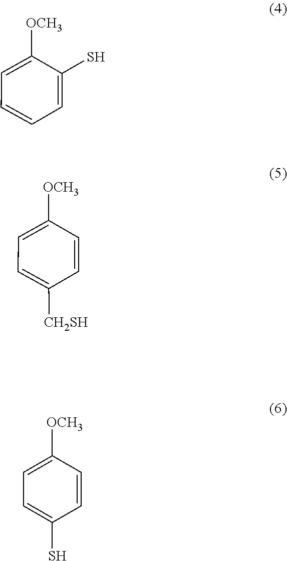

Whether or not the electrolytic solution contains the first compound(s) can be determined by analysis of the electrolytic solution. Specifically, the secondary battery 1 is disassembled, and the electrolytic solution is collected using a centrifuge and then analyzed. This makes it possible to specify the kinds of the components contained in the electrolytic solution such as the first compound(s). The method for analyzing the electrolytic solution is not particularly limited, and is specifically at least one or more kinds of high-frequency inductively coupled plasma (ICP) emission spectroscopy, nuclear magnetic resonance spectroscopy (NMR), gas chromatography mass spectrometry (GC-MS), or the like.

The solvent preferably further contains at least one of second compounds. The second compound is a linear ether. In the present disclosure, a linear ether refers to a linear compound having at least one ether bond. Here, the linear ethers include those in which hydrogen is replaced with a substituent not containing carbon. Specific examples of the linear ether include 1,2-dimethoxyethane (DME), diethyl ether (DEE), diethylene glycol dimethyl ether (G2), and triethylene glycol dimethyl ether (G3). The solvent more preferably contains 1,2-dimethoxyethane (DME). This makes it possible to reduce the viscosity of the electrolytic solution, improve the electrolytic ability of the electrolyte salt, and improve the mobility of ions in the electrolytic solution. As a result, the charge-discharge characteristics can be improved.

Whether or not the electrolytic solution contains the second compound(s) can be determined by analyzing the electrolytic solution in the same procedure as the determination of the presence or absence of the first compound(s).

In the present embodiment, the mole ratio of the first compound(s) to the second compound(s) in the electrolytic solution is preferably 1.8 or more, and more preferably 2.0 or more. The mole ratio of the first compound(s) to the second compound(s) in the electrolytic solution is calculated by dividing the total amount-of-substance (mol) of the first compound(s) contained in the electrolytic solution by the total amount-of-substance (mol) of the second compound(s) contained in the electrolytic solution. With this ratio, the physical properties of the electrolytic solution can be improved by the second compound(s) while the effect of the first compound(s), that is, the effect of forming a coating film derived from the anion of the electrolytic solution on the negative electrode is improved, and thus the charge-discharge characteristics can be further improved.

The mole ratio of the first compound(s) to the second compound(s) can be determined by analysis of the electrolytic solution. Specifically, the secondary battery 1 is disassembled, and the electrolytic solution is collected using a centrifuge and then analyzed. This makes it possible to measure each amount-of-substance of the first compound(s) and the second compound(s) contained in the electrolytic solution. The method for analyzing the electrolytic solution is at least one of ICP emission spectroscopy, NMR, or GC-MS.

The solvent may further contain other solvents other than the first compound(s) or the second compound(s).

Specifically, the other solvents are esters, cyclic ethers, and the like, and more specifically, carbonic acid ester-based compounds, carboxylic acid ester-based compounds, lactone-based compounds, and the like. The carbonic acid ester-based compound is a cyclic carbonic acid ester, a chain carbonic acid ester, and the like. Specific examples of the cyclic carbonic acid ester include ethylene carbonate and propylene carbonate. Specific examples of the chain carbonic acid ester include dimethyl carbonate, diethyl carbonate, and ethyl methyl carbonate. The carboxylic acid ester-based compound is a chain carboxylic acid ester or the like. Specific examples of the chain carboxylic acid ester include ethyl acetate, ethyl propionate, propyl propionate, and ethyl trimethylacetate. The lactone-based compound is a lactone or the like. Specific examples of the lactone include γ-butyrolactone and γ-valerolactone. Examples of the cyclic ethers include 1,2-dimethoxyethane, tetrahydrofuran, 1,3-dioxolane, and 1,4-dioxane.

In addition, an unsaturated cyclic carbonic acid ester, a fluorinated cyclic carbonic acid ester, a sulfonic acid ester, a phosphoric acid ester, an acid anhydride, a nitrile compound, an isocyanate compound, and the like may be contained as other solvents. This improves the electrochemical stability of the electrolytic solution. Specific examples of the unsaturated cyclic carbonic acid ester include vinylene carbonate, vinyl ethylene carbonate, and methylene ethylene carbonate. Specific examples of the fluorinated cyclic carbonic acid ester include monofluoro ethylene carbonate and difluoro ethylene carbonate. Specific examples of the sulfonic acid ester include propanesultone and propenesultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

The electrolyte salt contains a cation and an anion.

Examples of the cation of the electrolyte salt include alkali metal ions such as potassium ion, lithium ion, and sodium ion.

As the anion of the electrolyte salt, at least one of a hexafluorophosphate ion (PF₆⁻), a tetrafluoroborate ion (BF₄⁻), a trifluoromethanesulfonate ion (CF₃SO₃⁻), a bis(trifluoromethanesulfonyl)imide ion (N(CF₃SO₂)₂⁻), a tris(trifluoromethanesulfonyl)methide ion (C(CF₃SO₂)₃⁻), a bis(oxalato)borate ion (B(C₂O₄)₂⁻), or a nitrate ion (NO₃⁻) is preferably contained. With this, a coating film containing an inorganic substance such as LiF or Li₃N can be formed on the surface of the negative electrode by decomposition of the anion of the electrolyte salt.

As the anion of the electrolyte salt, at least one of a hexafluorophosphate ion (PF₆⁻), a tetrafluoroborate ion (BF₄⁻), a trifluoromethanesulfonate ion (CF₃SO₃⁻), a bis(trifluoromethanesulfonyl)imide ion (N(CF₃SO₂)₂⁻), or a tris(trifluoromethanesulfonyl)methide ion (C(CF₃SO₂)₃⁻) is more preferably contained. With this, the SEI containing fluorine can be formed on the surface of the negative electrode.

As the anion of the electrolyte salt, at least one of anions having an imide bond, such as lithium bis(fluorosulfonyl)imide (LiN(FSO₂)₂) or lithium bis(trifluoromethanesulfonyl)imide (LiN(CF₃SO₂)₂) is still more preferably contained. With this, a good ion pair of the anion of the electrolyte and the alkali metal ion is formed in the electrolytic solution, and the formation of the SEI can be promoted.

Specific examples of the electrolyte salt include lithium salts such as lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). With this, a high battery capacity can be obtained.

The content of the electrolyte salt is not particularly limited, and specifically, is preferably 0.3 mol/kg or more and 3.0 mol/kg or less with respect to the solvent. This makes it possible to improve the ion conductivity of the electrolytic solution.

The secondary battery 1 according to the present embodiment operates as follows in the battery element 20.

During charge, lithium is released from the positive electrode 21 and occluded in the negative electrode 22 through the electrolytic solution. On the other hand, during discharge, lithium is released from the negative electrode 22 and occluded in the positive electrode 21 through the electrolytic solution. At each of the time of discharge and the time of charge, lithium is occluded and released in an ionic state.

In the case of manufacturing the secondary battery 1 according to the present embodiment, each of the positive electrode 21, the negative electrode 22, and the electrolytic solution is produced using an example procedure described below, and then the secondary battery 1 is assembled, and the secondary battery 1 is subjected to a stabilization treatment. The method for manufacturing the secondary battery 1 described below is merely an example, and the present disclosure is not limited thereto.

First, a positive electrode active material, a positive electrode binder, and a positive electrode conductive agent are mixed with each other to obtain a positive electrode mixture. Subsequently, the positive electrode mixture is charged into a solvent to prepare a positive electrode mixture slurry in the form of paste. The solvent may be an aqueous solvent or an organic solvent.

Finally, the positive electrode mixture slurry is applied onto both surfaces of the positive electrode current collector 21A to form the positive electrode active material layer 21B. When the positive electrode active material layer 21B is formed, the positive electrode active material layer 21B may be compression-molded using a compression device such as a roll press machine. In the case of compression-molding the positive electrode active material layer 21B, the positive electrode active material layer 21B may be heated, or the compression-molding may be repeated a plurality of times. By forming the positive electrode active material layer 21B on both surfaces of the positive electrode current collector 21A according to the above procedure, the positive electrode 21 is produced.

The negative electrode 22 is formed by the same procedure as the production procedure of the positive electrode 21 described above. Specifically, a negative electrode active material, a negative electrode binder, and a negative electrode conductive agent are mixed with each other to produce a negative electrode mixture, and the negative electrode mixture is charged into a solvent to prepare a negative electrode mixture slurry in the form of paste. The solvent may be an aqueous solvent or an organic solvent. Then, the negative electrode mixture slurry is applied to both sides of the negative electrode current collector 22A to form the negative electrode active material layer 22B. Thereafter, the negative electrode active material layer 22B may be subjected to compression-molding. When the negative electrode active material layer 22B is formed, it may be compression-molded similarly to the positive electrode active material layer 21B. By forming the negative electrode active material layer 22B on both surfaces of the negative electrode current collector 22A according to the above procedure, the negative electrode 22 is produced.

In the case of manufacturing an electrolytic solution, an electrolyte salt is charged into a solvent containing the first compound(s) and the second compound(s). In this case, the mixing ratio of the first compound(s) and the second compound(s) is adjusted such that the mole ratio of the first compound(s) to the second compound(s) falls within the range described above. In this way, the electrolyte salt is dispersed or dissolved in the solvent, and an electrolytic solution is prepared.

First, the positive electrode lead 31 is connected to the positive electrode current collector 21A of the positive electrode 21 by a joining method such as a welding method, and the negative electrode lead 32 is connected to the negative electrode current collector 22A of the negative electrode 22 by a joining method such as a welding method.

Subsequently, the positive electrode 21 and the negative electrode 22 are stacked with the separator 23 interposed therebetween to form a stacked body. Subsequently, the stacked body is wound around the winding axis P according to FIG. 1 to produce a wound body, and then the wound body is pressed using a compression device such as a press machine to form the wound body into a flat shape. As a result, the wound body after molding has the same shape as the battery element 20.

Subsequently, after the wound body is housed in the recess 100, the exterior film 10 is folded to make a portion of the exterior film 10 and the other portion of the exterior film 10 face each other in the Z direction. Subsequently, the wound body is housed in the bag-shaped exterior film 10 by joining outer peripheries, on two sides, of the fusion layer portions facing each other using a bonding method such as a heat fusion method.

Finally, the electrolytic solution prepared above is injected into the bag-shaped exterior film 10, and then outer peripheries, on the remaining one side, of the fusion layer portions facing each other are joined to each other using a bonding method such as a heat fusion method. When the outer peripheries on the remaining one side are joined to each other, the sealing film 41 is inserted between the exterior film 10 and the positive electrode lead 31, and the sealing film 42 is inserted between the exterior film 10 and the negative electrode lead 32. In this way, the wound body is impregnated with the electrolytic solution, and the battery element 20 is produced.

As described above, the battery element 20 is sealed in the bag-shaped exterior film 10, and the secondary battery 1 according to the present embodiment is assembled.

The assembled secondary battery 1 is charged and discharged to be stabilized. Here, stabilization conditions such as an environmental temperature, the number of charge-discharge (the number of cycles), and charge-discharge conditions in the stabilization treatment can be suitably set. By the stabilization treatment, the above-described coating film is formed on the surface of the negative electrode 22, and the secondary battery 1 in which the battery element 20 is electrochemically stabilized is completed.

As described above, the secondary battery 1 according to the present embodiment includes the positive electrode 21, the negative electrode 22, and the electrolytic solution. The electrolytic solution contains at least one of first compounds represented by Formula (1), Formula (2), or Formula (3).

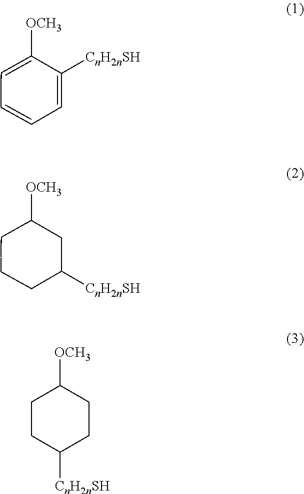

Here, n is an integer of 0 or more and 5 or less.

This allows for an increase of the boiling point of the electrolytic solution by the first compound to reduce the volatility and flammability of the electrolytic solution, thereby improving safety. In addition, since the first compound is less likely to be coordinated to an alkali metal ion such as a lithium ion, ion conductivity of the electrolytic solution can be reduced, and the charge-discharge characteristics can be improved.

As a desirable aspect, n in Formula (1), Formula (2), or Formula (3) is 0 or 1. This makes it possible to improve the solubility of the solute in the first compound(s) and the compatibility with a solvent such as the second compound(s).

As a desirable aspect, at least one of second compounds which are linear ethers is further contained. This makes it possible to reduce the viscosity of the electrolytic solution, improve the electrolytic ability of the electrolyte salt, and improve the mobility of ions in the electrolytic solution. As a result, the charge-discharge characteristics can be improved.

As a more desirable aspect, the mole ratio of the first compound(s) to the second compound(s) in the electrolytic solution is 1.8 or more. This makes it possible to improve the physical properties of the electrolytic solution by the second compound(s) while promoting the formation of a coating film on the negative electrode by the first compound(s). As a result, the charge-discharge characteristics can be further improved.

Next, modifications will be described. The configuration of the secondary battery according to the present embodiment can be appropriately changed as described below. Note that a series of modifications described below may be combined with each other.

The secondary battery according to the first modification is different from the secondary battery 1 described above in that it is a secondary battery utilizing precipitation and dissolution of lithium, a so-called lithium metal secondary battery.

The secondary battery according to the first modification has the same configuration as that of the secondary battery 1 described above except that the negative electrode 22 contains a simple substance of lithium, a so-called lithium metal. Specifically, the negative electrode 22 is a lithium metal foil or the like. However, the lithium metal may contain any suitable amount of impurities.

In the secondary battery according to the first modification, during charge, when lithium is released in an ionic state from the positive electrode 21, lithium metal is deposited on the surface of the negative electrode 22. In the secondary battery according to the first modification, during discharge, when lithium metal dissolves from the negative electrode 22, lithium is occluded in an ionic state in the positive electrode 21.

The method for manufacturing a secondary battery according to the first modification is the same as the method for manufacturing the secondary battery 1 described above except that lithium metal is used as the negative electrode 22.

Also in the secondary battery according to the first modification, since the battery capacity can be obtained by utilizing precipitation and dissolution of lithium, the same effect as that of the secondary battery 1 described above can be obtained.

The second modification is different from the secondary battery 1 described above in that a multilayered type separator including a polymer compound layer is used instead of the separator 23 which is a porous membrane.

Specifically, the multilayered type separator includes a porous membrane and a polymer compound layer. The porous membrane has a pair of surfaces. The polymer compound layer is provided on one surface or both surfaces of the porous membrane. This improves the close contact property of the separator to each of the positive electrode 21 and the negative electrode 22, so that the positional displacement of each of the positive electrode 21, the negative electrode 22, and the separator 23 can be suppressed at the time of winding. Thus, when a decomposition reaction of the positive electrolytic solution occurs, swelling of the secondary battery is suppressed.

The polymer compound layer preferably contains polyvinylidene fluoride or the like. This makes it possible to improve the physical strength and electrochemical stability of the polymer compound layer.

One or both of the porous membrane and the polymer compound layer may contain at least one or more kinds of a plurality of insulating particles. The plurality of insulating particles dissipate heat when the secondary battery generates heat, so that the heat resistance of the secondary battery can be improved and thus the safety can be improved. The plurality of insulating particles contain at least one or more kinds of insulating materials such as an inorganic material and a resin material. Specific examples of the inorganic material include aluminum oxide, aluminum nitride, boehmite, silicon oxide, titanium oxide, magnesium oxide, and zirconium oxide. Specific examples of the resin material include an acrylic resin and a styrene resin.

The separator according to the second modification is produced by preparing a precursor solution containing a polymer compound and an organic solvent and then applying the precursor solution to one surface or both surfaces of a porous membrane. In the production of the separator according to the second modification, a plurality of insulating particles may be contained in the precursor solution.

Also in the case of using the multilayered type separator according to the second modification, lithium can move in an ionic state between the positive electrode 21 and the negative electrode 22, so that the same effect as that of the secondary battery 1 described above can be obtained. In particular, in the second modification, swelling of the secondary battery can be suppressed.

In the secondary battery according to the third modification, a gel form electrolyte layer may be used instead of the liquid electrolytic solution.

In the battery element 20 using the electrolyte layer according to the third modification, the positive electrode 21 and the negative electrode 22 are wound while facing each other with the separator 23 and the electrolyte layer interposed therebetween. The electrolyte layer is interposed between the positive electrode 21 and the separator 23 and between the negative electrode 22 and the separator 23.

Specifically, the electrolyte layer contains an electrolytic solution and a polymer compound. In the electrolyte layer, the electrolytic solution is held by the polymer compound. This makes it possible to suppress liquid leakage of the electrolytic solution. The constituents of the electrolytic solution are the same as those of the electrolytic solution of the secondary battery 1 described above. Examples of the polymer compound include polyvinylidene fluoride.

The electrolyte layer according to the third modification is formed by preparing a precursor solution containing an electrolytic solution, a polymer compound, and a solvent, and then applying the precursor solution to one surface or both surfaces of each of the positive electrode 21 and the negative electrode 22.

Also in the case of using the electrolyte layer according to the third modification, lithium can move in an ionic state between the positive electrode 21 and the negative electrode 22 through the electrolyte layer, so that the same effect can be obtained. In particular, in the third modification, liquid leakage of the electrolytic solution can be suppressed.

Hereinafter, examples of the secondary battery according to the present embodiment will be described. The secondary battery according to the present embodiment is not limited to the following examples.

### Examples 1 to 5 and Comparative Example 1

In Examples 1 to 5 and Comparative Example 1, secondary batteries were manufactured according to the following procedure. The secondary batteries according to Examples 1 to 5 and Comparative Example 1 are simple lithium metal secondary batteries.

### [Production of Secondary Battery]

As the electrolytic solution, an electrolytic solution was prepared by charging an electrolyte salt into a solvent obtained by mixing a first solvent and a second solvent and stirring the mixture.

As the first solvent, a compound represented by Formula (4) (2-methoxybenzenethiol) was used in Examples 1 to 3, a compound represented by Formula (6) (4-methoxybenzenethiol) was used in Example 4, a compound represented by Formula (5) (4-methoxy-alpha-toluenethiol) was used in Example 5, and a compound represented by Formula (7) (anisole) was used in Comparative Example 1, as shown in Table 1 described later. That is, while the first compound according to the present embodiment was used as the first solvent in Examples 1 to 5, anisole was used in Comparative Example 1, instead of the first compound.

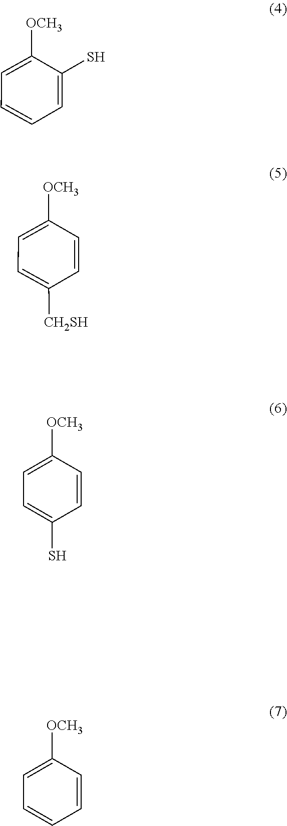

As the second solvent, 1,2-dimethoxyethane (DME) was used. That is, the second compound according to the present embodiment was used as the second solvent in Examples 1 to 5 and Comparative Example 1. Here, the solvents were prepared such that the mole ratio of the first solvent to the second solvent was 1.8 in Example 1, and was 2.0 in Examples 2 to 5 and Comparative Example 1, as shown in Table 1 described later.

As the electrolyte salt, lithium bis(fluorosulfonyl)imide (LiFSI) was used. Here, the electrolytic solutions were prepared such that the concentration of the electrolyte salt with respect to the solvent was 2 mol/L in Examples 1, 2, 4, and 5 and Comparative Example 1, and 3 mol/L in Example 3, as shown in Table 1 described later.

The test electrode was produced by pressure bonding a lithium metal foil having a thickness of 0.1 mm to a copper foil having a thickness of 0.01 mm using a press machine. The counter electrode was a copper foil having a thickness of 0.012 mm. As the separator, a microporous polyethylene film having a thickness of 10 μm was used. By dropping the produced electrolytic solution, the separator was impregnated with the electrolytic solution. The amount of the electrolytic solution dropped was 0.01 mL. Thereafter, the test electrode, the separator impregnated with the electrolytic solution, and the counter electrode were stacked in this order to produce a secondary battery for a charge-discharge test.

The secondary battery produced above was subjected to a charge-discharge test by the following method as an evaluation of battery characteristics to measure the coulombic efficiency.

In the charge-discharge test, measurement was performed by conducting charge-discharge cycles a plurality of times. Specifically, each of the charge capacity and the discharge capacity was measured by charging and discharging the secondary battery in an environment at a temperature of 23° C. in each cycle. At the time of charging, the battery was charged at a current density of 0.22 mA/cm² until the total charge time reached 3 hours, and at the time of discharging, the battery was discharged until the voltage reached 0.1 V. Then, the coulombic efficiency was calculated for every cycle based on a calculation formula: coulombic efficiency (%)=(discharge capacity/charge capacity)×100.

In the charge-discharge test, the secondary battery was repeatedly charged and discharged until the charge-discharge reached 25 cycles to measure the coulombic efficiency. Then, the average coulombic efficiency (%) was calculated by averaging the values of 16 coulombic efficiencies calculated for every cycle in each of the 10th cycle to the 25th cycle. Here, the reason why only the coulombic efficiencies from the 10th cycle to the 25th cycle are adopted in the calculation of the average coulombic efficiency is to improve the accuracy and reproducibility of the evaluation of the charge-discharge characteristics. Since the value of the coulombic efficiency is likely to vary in the first to ninth cycles, the average coulombic efficiency was calculated without adopting the coulombic efficiency from the first to ninth cycles.

Table 1 shows the constituents of the electrolytic solutions of the secondary batteries according to Examples 1 to 5 and Comparative Example 1 and the results showing the charge-discharge characteristics. Here, in Table 1, the “first solvent/second solvent” refers to a ratio of the amount-of-substance of the first solvent contained in the electrolytic solution to the amount-of-substance of the second solvent contained in the electrolytic solution.

TABLE 1

| | | | First | | Electrolyte | |
|---|---|---|---|---|---|---|
| | | | solvent/ | | salt | Average |
| | First | Second | second | Electrolyte | concentration | coulombic |
| | solvent | solvent | solvent | salt | (mol/L) | efficiency |
| Example 1 | Formula (4) | DME | 1.8 | LiFSI | 2 | 99.22% |
| Example 2 | Formula (4) | DME | 2.0 | LiFSI | 2 | 99.29% |
| Example 3 | Formula (4) | DME | 2.0 | LiFSI | 3 | 99.76% |
| Example 4 | Formula (6) | DME | 2.0 | LiFSI | 2 | 99.23% |
| Example 5 | Formula (5) | DME | 2.0 | LiFSI | 2 | 99.80% |
| Comparative | Formula (7) | DME | 2.0 | LiFSI | 2 | 78.43% |
| Example 1 | | | | | | |

As shown in Table 1, in Examples 1 to 5 using the first compound represented by any one of Formulae (4) to (6) as the first solvent, the average coulombic efficiency was improved as compared with Comparative Example 1 using the anisole represented by Formula (7). Thus, it is found that the charge-discharge characteristics are improved when the electrolytic solution contains the first compound.

As shown in Table 1, in Examples 1 to 5 in which the ratio of the first solvent to the second solvent, that is, the ratio of the first compound to the second compound was 1.8 or more, the average coulombic efficiency was 99% or more. Thus, it is found that when the ratio of the first compound to the second compound is 1.8 or more, the charge-discharge characteristics are good.

As shown in Table 1, in Examples 2 to 4 in which the ratio of the first solvent to the second solvent, that is, the ratio of the first compound to the second compound was 2.0 or more, the average coulombic efficiency was improved as compared with Example 1 in which the ratio of the first compound to the second compound was less than 2.0. Thus, it is found that when the ratio of the first compound to the second compound is 2.0 or more, the charge-discharge characteristics are further improved.

The above contents are intended to facilitate understanding of the present disclosure, but not intended to construe the present disclosure in any limited way. The present disclosure can be modified or improved without departing from the gist thereof, and equivalents thereof are also included in the present disclosure.

For example, the battery structure of the secondary battery may be a cylindrical type, a rectangular parallelepiped type, a coin type, a button type, or the like.

The element structure of the battery element may be a stacked type, a zigzag folded type, or the like. In the stacked type, the positive electrode and the negative electrode are alternately stacked with the separator interposed therebetween. In the zigzag folded type, the positive electrode and the negative electrode are folded in a zigzag manner while facing each other with the separator interposed therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode;
and an electrolytic solution,
wherein the electrolytic solution contains at least one of first compounds represented by Formula (1), Formula (2), or Formula (3): 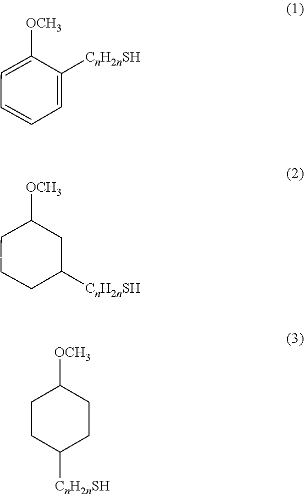
wherein n is an integer of 0 or more and 5 or less.

2. The secondary battery according to claim 1, wherein n is 0 or 1.

3. The secondary battery according to claim 1, wherein the electrolytic solution further contains at least one of second compounds that are linear ethers.

4. The secondary battery according to claim 3, wherein a mole ratio of the first compounds to the second compounds in the electrolytic solution is 1.8 or more.
